(19) United States
(12) Patent Application Publication
(10) Pub. No.: US 2006/0088137 A1
(43) Pub. Date: Apr. 27, 2006

(54) Multi-frequency clock stretching systems

(75) Inventors: Xicheng Jiang, Irvine, CA (US); Chun-Ying Chen, Irvine, CA (US)

Correspondence Address: STERNE, KESSLER, GOLDSTEIN & FOX PLLC, 1100 NEW YORK AVENUE, N.W., WASHINGTON, DC, 20005, US

(73) Assignee: Broadcom Corporation, Irvine, CA (US)

(21) Appl. No.: 11/256,169

(22) Filed: Oct. 24, 2005

Related U.S. Application Data
(60) Provisional application No. 60/621,471, filed on Oct. 25, 2004.

(51) Int. Cl. H04L 7/00

(52) U.S. Cl. 375/371

(57) ABSTRACT

A multi-frequency clock stretching system is provided. The multi-frequency clock stretching system includes a stretch pulse generator that generates a stretch pulse signal and a multi-frequency clock generator that produces a set of different frequency clock signals in which the clock signal pulses of the set of different frequency clock signals can be stretched as a function of the stretch pulse signal. A data processing system is also provided that includes a data processing portion and a multi-frequency clock stretching system. When the data processing portion recognizes that a clock adjustment is needed, the data processing portion provides a control signal to the multi-frequency clock stretching system that stretches the pulses of clock signals serving as inputs to the data processing portion to better align the pulses and improve system performance.

### CROSS REFERENCE TO RELATED APPLICATIONS

This application claims the benefit of priority to U.S. Provisional Patent Application, Application No. 60/621,471, filed Oct. 25, 2004, which is incorporated herein by reference in its entirety.

### BACKGROUND OF THE INVENTION

1. Field of the Invention

The invention relates to high speed data systems, and more particularly to multi-frequency clock stretching systems.

2. Background Art

High speed data systems, such as high speed data acquisition systems frequently require adjustments to the phases of clocks used to sample incoming data. A failure to properly adjust the phases of clocks can lead to high bit error rates and degrade system performance. For example, if low speed data is serialized in later stages of a data acquisition system, then all higher speed clock phases used in the later stages that require a fixed timing relationship with the first sample clock, are required to be adjusted accordingly.

Existing systems and methods to ensure the proper phase of sampling clocks are often complicated and use excessive power. For example, one approach uses multiplexers and counters to choose the right phase to be used for each of the sampling clock signals. This approach requires many extra circuits and power consumption is relatively high. In another approach a phase rotator and digital logic are used to select the clock phase of the sampling clocks. Using this approach, the resulting circuitry is often very complicated and therefore costly to implement.

Commonly owned, co-pending U.S. Patent Application, entitled Pulse Stretching Architecture for Phase Alignment for High Speed Data Acquisition, Attorney Docket 1875.7160001, which is herein incorporated by reference in its entirety, described an architecture that addresses clock phase alignment challenges for high speed data acquisition systems. The architecture disclosed in that application describes an approach for aligning phases of multi-frequency clocks.

What are needed are multi-frequency clock stretching systems that can support architectures, such as those described in the above co-pending application, as well as provide clock stretching systems to align clocks in a wide range of other types of digital devices that have a need to align clock pulses to improve device performance.

### BRIEF SUMMARY OF THE INVENTION

Multi-frequency clock stretching systems are provided. A multi-frequency clock stretching system includes a stretch pulse generator that generates a stretch pulse signal and a multi-frequency clock generator that produces a set of different frequency clock signals in which the clock signal pulses of the set of different frequency clock signals can be stretched as a function of the stretch pulse signal. A data processing system is also provided that includes a data processing portion and a multi-frequency clock stretching system. When the data processing portion recognizes that a clock adjustment is needed, the data processing portion provides a control signal to the multi-frequency clock stretching system that stretches the pulses of clock signals serving as inputs to the data processing portion to better align the pulses and improve system performance.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of a data processing system.

FIG. 2 is a diagram of multi-frequency clock generator.

FIG. 3 is a diagram of stretch pulse generator.

FIG. 4 is a diagram of a high speed data acquisition system that includes a multi-frequency clock stretching system.

FIG. 5 is a diagram that shows the timing relationship of various control signals and clock signals.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE INVENTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of utility.

The timing or the phase relationship between the incoming data from a transmitter and the receiving clock in a receiver is very important within data communications. A phase misalignment between the clock and the data will increase the system bit error rate. However, it is difficult to control the right clocking phase to the incoming data in high speed data communications because not only are the clock periods relatively short, but also various factors affect the propagation delay in a data path, which results in a small timing margin or error. For example, if a transmitter and a receiver are in two different chips, the printed circuit board (PCB) and the buffer stages in each chip contribute propagation delays that are a function of process, temperature and voltage.

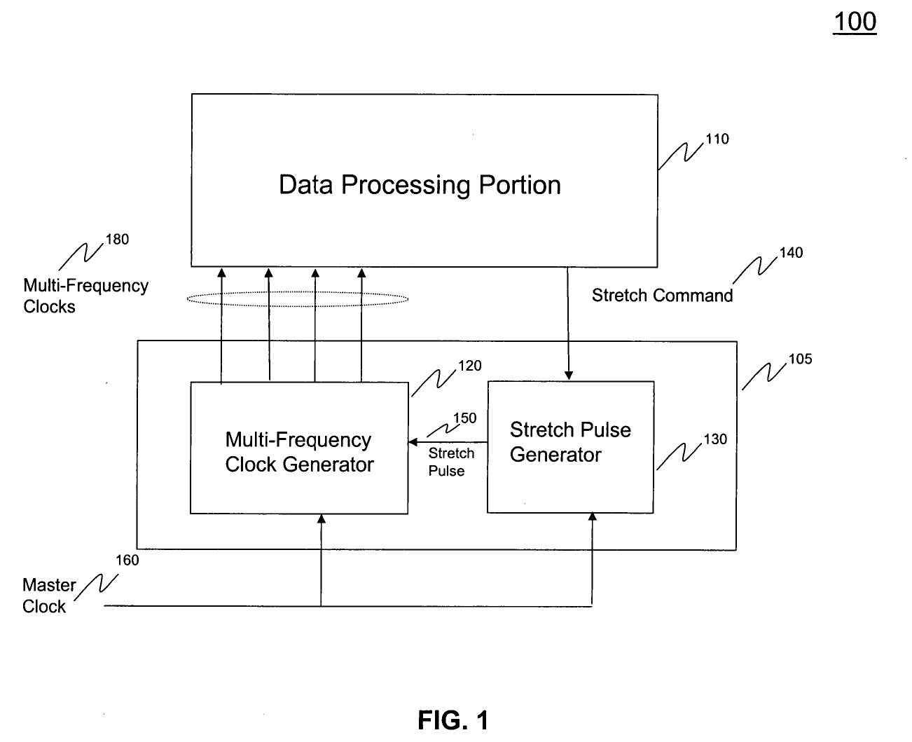

FIG. 1 provides a diagram of a data processing system 100. Data processing system 100 includes data processing portion 110 and multi-frequency clock stretching system 105. Multi-frequency clock stretching system 105 includes multi-frequency clock generator 120 and stretch pulse generator 130.

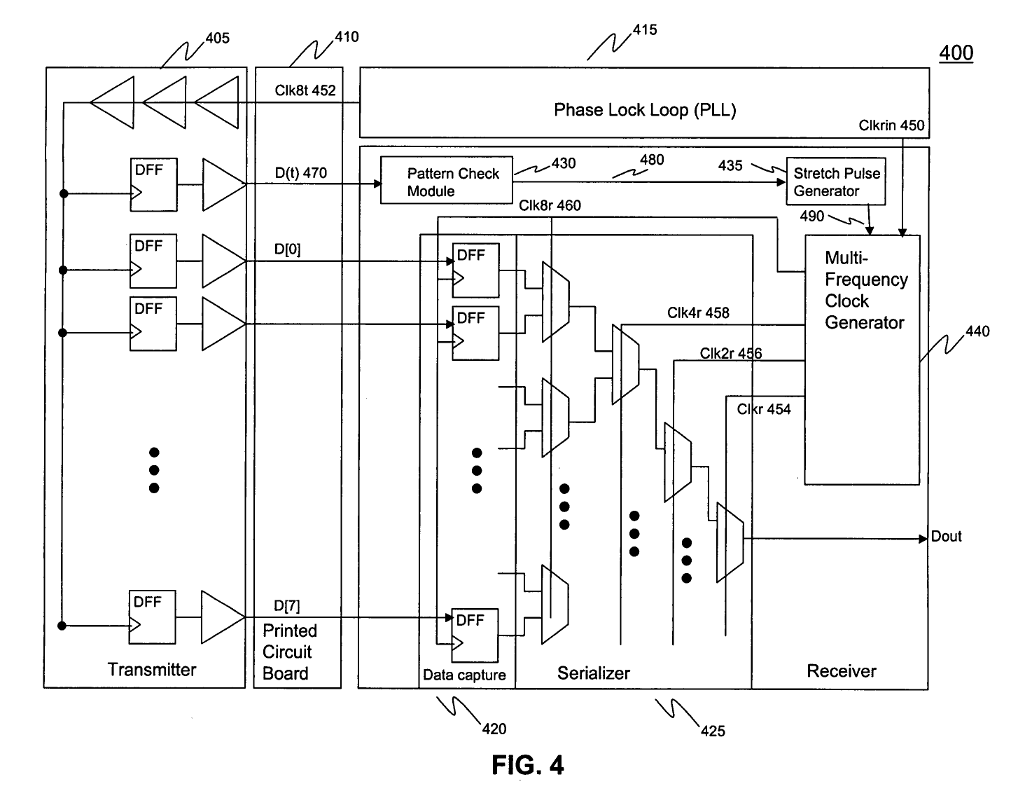

Data processing portion 110 processes digital data. For example, data processing portion 110 can receive parallel digital data and serialize that data to provide a single serial data output signal. FIG. 4 provides an illustrative example of such a system that further explains the operation and integration of a multi-frequency clock stretching system 105 with an exemplary data processing portion 110. Data processing portion 110 can provide any type of digital data processing that requires the use of multiple frequency clock signals with the need to have aligned phases of the clock signals or to have phases adjusted to optimize data sampling or other data processing functions.

When data processing portion 110 determines that an adjustment needs to be made to the multi-frequency clock signals 180, data processing portion 110 provides stretch command signal 140 to stretch pulse generator 130. For example, when a bit error rate exceeds a performance threshold with data processing portion 110, a stretch command signal 140 is generated. Stretch command signal 140 is a digital signal of any duration.

Stretch pulse generator 130 receives stretch command signal 140 from data processing portion 110. Upon receipt of stretch command signal 140, stretch pulse generator 130 generates a stretch pulse signal 150. Stretch pulse signal 150 may have a period that is equal to that of master clock signal 160. Alternatively, stretch pulse signal 150 can have a period that is an integer or fractional multiple of the period of master clock signal 160.

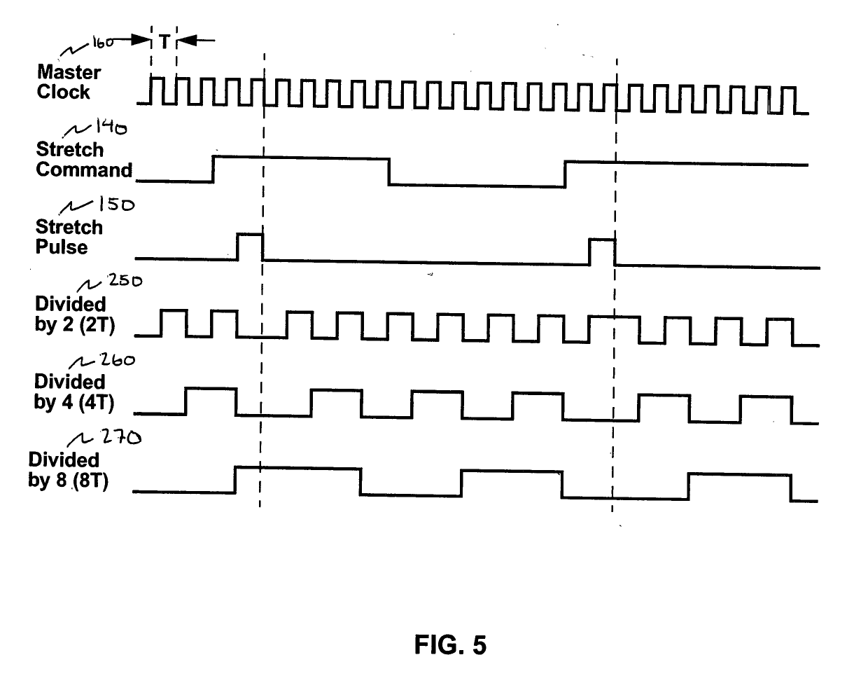

Multi-frequency clock generator 120 produces different frequency clock signals 180. Each of the clock signal pulses having different frequencies can be stretched as a function of stretch pulse signal 150. That is, as is illustrated in FIG. 5, when stretch pulse signal 150 is high, the current period of each of the clock signals can be stretched.

In one embodiment, as is illustrated in FIG. 5, all clocks of multi-frequency clock signals 180 have a single period that is stretched by the period of stretch pulse signal 150. In an alternative embodiment, selected clock signals of multi-frequency clocks 180 have a single period that is stretched, whiles the pulses of other clocks remain unaffected by stretch pulse signal 150. In yet another embodiment, all clocks of multi-frequency clock signals 180 have a single period that is stretched by a multiple or fraction of the period of stretch pulse signal 140.

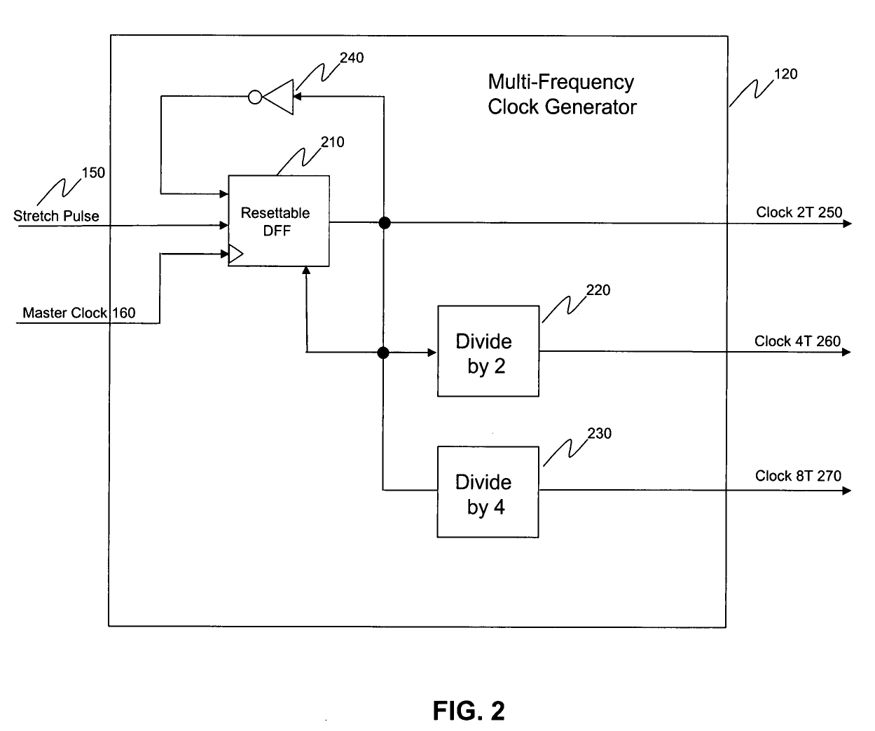

FIG. 2 provides a diagram of multi-frequency clock generator 120. In this example, multi-frequency clock generator 120 generates three output clocks, clock 2T 250, clock 4T 260 and clock 8T 270, where T is the period of the master clock signal 160.

Multi-frequency clock generator 120 includes resettable D flip-flop 210, divide-by-2 divider 220, divide-by-4 divider 230 and inverter 240. Resettable D flip-flip 210 receives input signals that include stretch pulse signal 150 and master clock signal 160, which has a period of 1 T. Additionally, resettable D-flip-flop 210 receives a feedback signal from its D output through inverter 240. Resettable D flip-flop 210 is configured such that when stretch pulse signal 150 is equal to zero, resettable D flip-flop 210 outputs a nT clock signal, where n is any positive integer. In the example of FIG. 2, the n equals 2, such that the output signal is clock 2T 250, which has a period of 2 T. When stretch pulse signal 150 is equal to a one, resettable D flip-flop 210 resets Clock 2T 250 clock signal to the current Clock 2T 250 level for a period equal to the width of stretch pulse signal 150. That is, an output pulse for clock 2 T is stretched by 1 T. In other words, when stretch pulse signal 150 is equal to one (or in a high state), the internal states within resettable D flip-flop 210 are set to the immediate previous states for a period equal to the stretch pulse signal width, such that a pulse of Clock 2T 250 is stretched by the width of stretch pulse signal 150.

The output signal of resettable D flip-flop 210, which is clock 2T 250, is provided as an input to divide-by-2 divider 220, which produces clock signal, clock 4T 260, which has a period of 4 T. Additionally, the clock 2T 250 signal is provided to divide-by-4 divider 230 to produce clock signal, clock 8T 270, which has a period of 8 T. The output signal of resettable D flip-flop 210 is also fedback through inverter 240 as an input signal into resettable D flip-flop 210.

The invention is not limited to producing three output clocks. Any number of output clocks could be provided with different frequencies by adding additional dividers. Furthermore, because all output clocks are derived from the Clock 2T 250 signal, in this example, all phases of the output clocks will be shifted by the same amount. In other embodiments, selected clock outputs can be shifted, while others are not, as will be apparent to persons skilled in the relevant arts based on the teachings herein.

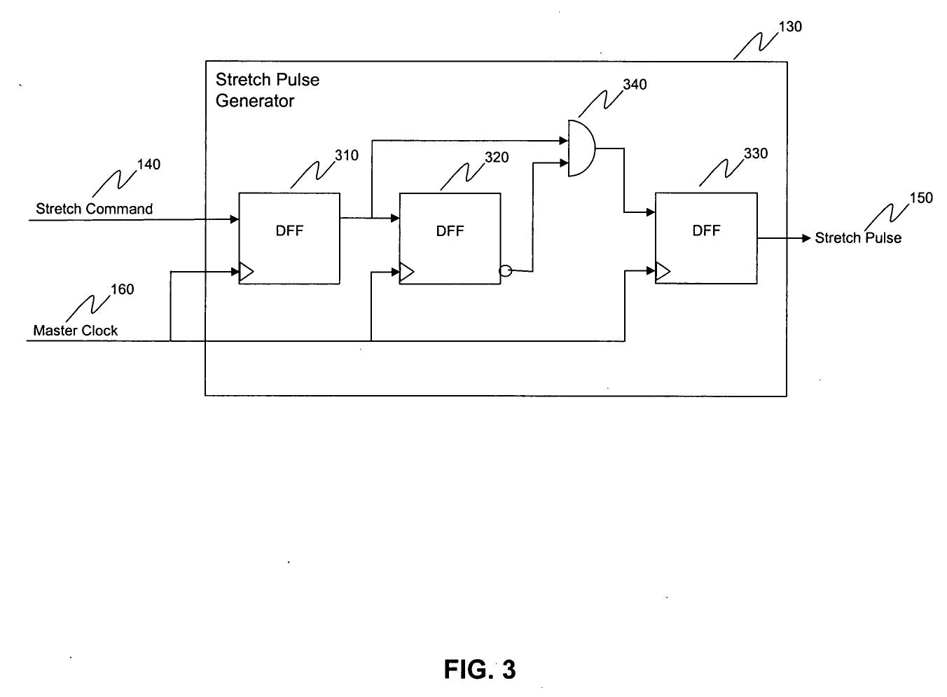

FIG. 3 provides a diagram of stretch pulse generator 130. Stretch pulse generator 130 includes D flip-flop 310, D flip-flop 320, D flip-flop 330 and AND gate 340. D flip-flop 310 receives a stretch command signal 140 and master clock signal 160. The output of D flip-flop 310 is coupled to the input of D flip-flop 320 and serves as one of the inputs to AND gate 340. D flip-flop 320 also receives master clock signal 160 as its clock input. The output of D flip-flop 320 serves as an additional input to AND gate 340. The output of AND gate 340 is coupled to the input of D flip-flop 330. D flip-flop 330 also receives master clock 160 as its clock input. D flip-flop 330 outputs stretch pulse signal 150. A timing diagram illustrating the relationship between stretch command signal 140, stretch pulse signal 150 and the various clock signals is provided in FIG. 5.

FIG. 4 provides a diagram of high speed data acquisition system 400 that includes a pulse stretching architecture for phase alignment of multi-frequency clocks. The data processing portion of high speed data acquisition system 400 includes transmitter 405, printed circuit board 410, phase lock loop 415, data capture module 420, serializer 425 and pattern check module 430. The multi-frequency clock stretching system includes stretch pulse generator 435 and multi-frequency clock generator 440.

Transmitter 405 transmits parallel digital data to data capture module 420. Serializer 425 processes the received data and outputs the received parallel data as a serial data stream.

Data capture module 420 provides for the initial capture of parallel data received from transmitter 405. Serializer 425 multiplexes the digital parallel input data received from transmitter 405 to a single high speed data path. Multi-frequency clock generator 420 generates a variety of output clocks that are used to synchronize data capture module 420 and serializer 425.

High speed clock signals, clkrin 450 and clk8t 452 are generated by phase lock loop (PLL) circuit 415. PLL circuit 415 transmits clkrin 450 to multi-frequency clock generator 440. Based on clkrin 450, multi-frequency clock generator 440 generates the necessary lower-speed clocks for use in serializer 425. In particular, multi-frequency clock generator 440 generates clk8r 460, clk4r 458, clk2r 456 and clkr 454. The clkr8r 460 signal is provided to the clock inputs of flip-flops in data capture module 420. The clk8r 460, clk4r 458, clk2r 456 and clkr 454 signals are provided to gates within the various stages in serializer 425.

PLL circuit 415 provides a clock signal, clk8t 410, to transmitter 405 that provides the clock inputs of flip flops within transmitter 405 to synchronize the parallel output data.

In addition to sending data signals, transmitters, such as transmitter 405, typically send out known data or test patterns, such as D(t) 330 470. These signals such as, for example, a parity pattern are recognized by a receiver. High speed data acquisition system 400 uses this data to help determine whether clock phase alignment is necessary.

In particular, pattern check module 430 receives the D(t) 470 and calculates a performance measure, such as, for example a bit error rate (BER). Based on its evaluation of D(t) 470 and the associated BER, pattern check module 430 sends stretch command signal 480 to stretch pulse generator 435.

As discussed above, the function of pulse stretch generator 435 is to generate a stretch pulse signal 490 and provide that signal to multi-frequency clock generator 440. When stretch pulse signal 490 is enabled, multi-frequency clock generator 440 will absorb one clock cycle of clkr 450 and stretch out the periods of clk2r 456, clk4r 458, and clk8r 460. Thus, equivalently the phase of clk8r 460 relative to the incoming data is delayed by a clock period of clkrin 450, whenever stretch pulse signal 490 is enabled. That is, when stretch command signal 480 is enabled, the timing (or the phase) of the lower speed clocks will be adjusted by one period of high speed clock, clkrin 450.

FIG. 5 is a diagram that shows the timing relationship of various control signals and clock signals. FIG. 5 illustrates master clock 160, stretch command signal 140, stretch pulses 150, clock signal 2T 250, clock signal 4T 260 and clock signal 8T 270. Master clock 160 can be a 2.3 Ghz clock, but is not limited to this frequency. As can be seen from FIG. 5, when stretch command 140 goes high, a stretch pulse signal 150 is generated. When this occurs the pulses for each of the clocks is stretched by the width of the stretch pulse signal 150.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A multi-frequency clock stretching system, comprising:
a stretch pulse generator that generates a stretch pulse signal; and
a multi-frequency clock generator that produces a plurality of different frequency clock signals, wherein clock signal pulses of the plurality of different frequency clock signals can be stretched as a function of the stretch pulse signal.

2. The multi-frequency clock stretching system of claim 1, wherein all clock signals among the plurality of different frequency clock signals are stretched as a function of the stretch pulse signal.

3. The multi-frequency clock stretching system of claim 1, wherein selected clock signals among the plurality of different frequency clock signals are stretched as a function of the stretch pulse signal.

4. The multi-frequency clock stretching system of claim 1, further comprising:
a resettable D flip-flip with input signals that include a stretch pulse signal having a pulse width and a 1 T clock, wherein internal states within the resettable D flip-flop are set to the immediate previous states for a period equal to the stretch pulse signal width.

5. The multi-frequency clock stretching system of claim 1, wherein the multi-frequency clock generator comprises:
a resettable D flip-flip with input signals that include a stretch pulse signal and a 1 T clock, and
wherein when the stretch pulse signal is equal to a zero, the resettable D flip-flop outputs a nT clock signal,
wherein when the stretch pulse signal is equal to a one, the resettable D flip-flop resets the nT clock signal output to the current clock nT level for a period equal to the width of the stretch pulse signal,
wherein 1 T equals a clock period of time T and nT equals a clock period that is n times the duration of the 1 T clock period.

6. The multi-frequency clock stretching system of claim 5, wherein n equals 2.

7. The multi-frequency clock stretching system of claim 5, further comprising:
a divide-by-n divider that receives the nT clock signal and generates a 2 nT clock signal; and
a divide-by-2n divider that receives the nT clock signal and generates a 4 nT clock signal.

8. The multi-frequency clock stretching system of claim 1, wherein said stretch pulse generator comprises:
a first digital D flip-flop that receives a stretch command signal and a master clock signal;
a second digital D flip-flop that receives an output from the first digital D flip-flop and a master clock signal;
an AND gate that receives an output from the first digital D flip-flop and an output from the second digital D flip-flop; and
a third digital D flip-flop that receives an output from the AND gate and the master clock signal and produces a stretch pulse signal.

9. The multi-frequency clock stretching system of claim 1, wherein said stretch pulse generator receives a stretch command signal and a master clock input signal and outputs a stretch pulse signal, and wherein the stretch command signal can be of a digital signal of any duration and the stretch pulse signal has a duration that is equal to that of the master clock period or an integer multiple of the master clock period.

10. A data processing system, comprising:
a data processing portion;
a stretch pulse generator that generates a stretch pulse signal; and
a multi-frequency clock generator that produces a plurality of different frequency clock signals, wherein clock signal pulses of the plurality of different frequency clock signals can be stretched as a function of the stretch pulse signal, and wherein the plurality of different frequency clock signals are transmitted to the data processing portion.
